(19) United States
(12) Patent Application Publication
(10) Pub. No.: US 2013/0331632 A1
(43) Pub. Date: Dec. 12, 2013

(54) PROCESS FOR SEPARATION AND RECOVERY OF CUTTINGS, EMULSION AND SLURRY COMPONENTS

(71) Applicant: Ronald N. Drake, Helena, MT (US)

(72) Inventor: Ronald N. Drake, Helena, MT (US)

(21) Appl. No.: 13/904,750

(22) Filed: May 29, 2013

Related U.S. Application Data
(60) Provisional application No. 61/652,615, filed on May 29, 2012.

(51) Int. Cl. C10G 70/00; B01D 3/00

(52) U.S. Cl. CPC C10G 70/00; B01D 3/009
USPC 585/802; 202/185.1

(57) ABSTRACT

This disclosure describes systems, methods, and apparatus for separating and purifying components from mixtures and emulsions containing hydrocarbons, water, salt, and mineral solids. Key unit operations are thermal desorbing, hot filtering, direct contact condensing, solids leaching, evaporating, and salt precipitating. Preferred embodiments of the process and system use process-generated fuel, leach water, and hot combustion gas to conduct thermal desorption, solids leaching, and salt precipitating. Use of process generated streams for key unit operations greatly reduces the need for purchased utilities and contributes both to process efficiency and economy.

### CLAIM OF PRIORITY UNDER 35 U.S.C. §119

The present application for patent claims priority to Provisional Application No. 61/652,615 entitled “PROCESS FOR SEPARATION AND RECOVERY OF CUTTINGS, EMULSION AND SLURRY COMPONENTS” filed May 29, 2012, and assigned to the assignee hereof and hereby expressly incorporated by reference herein.

### FIELD OF THE INVENTION

The present disclosure relates generally to fossil fuel production treatment, and in particular to treating wastes from fossil energy exploration, production, transportation, and refining.

### BACKGROUND OF THE INVENTION

As compared to traditional vertical hydrocarbon drilling equipment, horizontal drilling now requires a new level of drill bit lubrication. These new drilling fluids, sometimes referred to as “invert mud,” typically comprise mixtures of aqueous and organic liquid phases that are emulsified and bound together by various surface active agents (surfactants). The aqueous liquid phase is often salt brine while the organic liquid phase often contains crude oil or diesel range organics. Drillers add the surfactants to ensure that the aqueous and organic phases do not separate during drilling. The surfactants can include, but are not limited to, soaps, detergents, emulsifiers, emulsion breakers, polymers, fatty acids, amines, amides, glycerol, alcohols, barium sulfate or other salts of organic acids and esters, and other proprietary ingredients.

Such drilling fluids would not pose environmental hazards if the fluid could be indefinitely reused as a drill bit lubricant. However, these fluids not only lubricate the drill bit, but also move drill cuttings (e.g., mineral fines, salt brine, and crude oil) to the surface, thus turning the drilling fluids into oilfield wastes (or “waste”) that eventually require treatment and/or disposal. Other contaminants may include barite, bentonite, sand, proppants, filter aids, corrosion products, scale, biological materials, dust, and dirt, to name a few. At this point, the oilfield wastes require disposal, yet merely dumping such concoctions into the ground is not a feasible option.

Some have attempted, unsuccessfully, to mix wastes with fly-ash or other solid sorbents so as to render the mixture non-leachable and thus suitable for disposal in nearby pits (referred to as “on-site disposal”). Yet, these methods have been so environmentally hazardous that North Dakota outlawed the practice in 2012 and similar prohibitions will likely follow, thus creating the need for alternative treatment and/or disposal solutions.

Off-site treatment or disposal is another alternative. Currently North Dakota has three secure hazardous waste landfills where oilfield wastes can be disposed of, but this requires expensive transport of the wastes and is unsustainable. To minimize waste transport and disposal costs, drillers have implemented expensive, on-site, solids separation systems (so-called “closed loop” systems) to separate cuttings solids from drilling fluids in order to allow maximum recycle of the valuable drilling mud components. The closed-loop systems often comprise screens, centrifuges, sedimentation, and sometimes dryers that attempt to separate the drill cuttings and other contaminants from the drilling fluids (the inventor is not aware of any thermal desorption methods being applied to this particular waste feed). These closed-loop systems all attempt separation of mixtures/emulsions in a liquid state. The organically-contaminated solids removed from the wastes still require off-site disposal, but at least in less volume than if on-site treatment were not performed. However, on-site treatment is ineffective to remove all solid fines (e.g., <10 μm) in the recycled drilling fluids, and thus the recycled drilling fluids eventually become unusable because of an accumulation of solid fines (e.g., 20%-30%). The drilling fluid is therefore eventually disposed of. Thus, these on-site treatments merely reduce the rate of waste disposal rather than eliminate an amount of waste that eventually is put into landfills.

Because on-site pit disposal is becoming less of an option, off-site disposal is expensive and still environmentally unsustainable, and on-site treatment is expensive and merely reduces the rate of off-site disposal required, some drillers have turned to tank storage until more effective treatment methods are developed, or worse they engage in improper and illegal disposal. Furthermore, the drilling fluids from a single well include tens of thousands of dollars worth of organics (e.g., diesel fuel) that would be lost if not recovered from the wastes, and are lost when drilling fluids are eventually disposed of. There is thus a need in the art for on-site treatment that produces tractable products/solutions that can be reused and disposed of in the ground without causing or risking environmental harm.

Additionally, existing treatment methods are unable to effectively handle “rag-layer.” Drillers add substantial quantities of surfactants and emulsifiers to oil based drilling fluids in order to prevent separation of the organic and aqueous phases in the down-hole environment. In the presence of cuttings fines, the residual surfactants often form a persistent and stable dirty emulsion or “rag layer” that have no commercial value, hinder treatment operations, and can plug expensive wells if accidentally sent “down hole.” Thus, many injection well facilities now have large tank batteries full of rag layer material waiting for future disposal or treatment methods to be developed. There is thus a need for treatment methods for separating rag layer into reusable or environmentally-friendly products.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as a method for treating oilfield wastes. The method can include separating an oilfield waste feed into a first vapor stream and a first solids stream via thermal desorption. The first vapor stream can include hydrocarbon vapor, water vapor, and solid fines. The first solids stream can include salts and solids having a larger average mass than the solid fines. The method can further include separating the solid fines from the first vapor stream to produce a second vapor stream and a second solids stream. The second vapor stream can include hydrocarbon and water vapors and can be substantially free of solids.

Other embodiments of the disclosure can be characterized as a system for treating oilfield wastes comprising a thermal desorber, a hot vapor filter, a vapor condenser, a liquids separator, a solids leacher, a salt crystallizer, and a water vapor condenser. The thermal desorber can receive waste feed and produce a first and second stream. The first stream can include hydrocarbon vapors and water vapors and possibly some solid fines. The second stream can include mineral and salt solids and can be substantially free of hydrocarbons and moisture. The hot vapor filter can receive the first stream of hydrocarbon and water vapors that contain some solid fines. From this first stream the hot vapor filter can generate a solids-free vapor stream and a stream of solid fines. The vapor condenser can receive the solids-free vapor stream and can generate a mixed liquids stream from the solids-free vapor stream. The mixed liquids stream can include hydrocarbons and water. The liquids separator can receive the mixed liquids stream and can generate therefrom, a liquid hydrocarbon stream and a first liquid water stream. The solids leacher can receive the second stream of mineral and salt solids from the thermal desorber and can receive the stream of solid fines from the hot vapor filter. From these streams, the solids leacher can generate a stream of salt-free damp solids and a stream of salt brine. The salt crystallizer can receive the stream of salt brine and generate a damp salt cake and water vapor from it. The water vapor condenser can receive the water vapor and generate a second liquid water stream.

Yet further embodiments of the disclosure can be characterized as a system including a thermal desorber and a hot filter. The thermal desorber can receive an oilfield waste feed and apply thermal energy to the oilfield waste feed in order to vaporize liquid components in the oilfield waste feed. This can generate a first vapor stream and a solids stream. The solids stream can include a first portion of solids in the oilfield waste feed. The hot filter can receive the first vapor stream and filter the first vapor stream in order to remove a second portion of solids from the first vapor stream. This generates a second vapor stream and a second solids stream. An average particle mass of the second solids stream can be smaller than an average particle mass of the first solids stream.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates one embodiment of a method for separation of emulsions, cuttings and slurry components produced at various points in the hydrocarbon production process.

FIG. 2 illustrates one embodiment of a system for carrying out the thermal desorbing and vapor/solids separating.

### DETAILED DESCRIPTION

To realize the aforementioned benefits and to overcome the disadvantages of existing technologies, Applicant has developed on-site systems, methods, and apparatus for separating and recovering major components of oilfield wastes. Such solutions are particularly applicable to oil/water emulsions having solid fines in them, since such waste emulsions are typically intractable for traditional treatment systems. The systems, methods, and apparatus of this disclosure are even applicable to waste feeds comprising an emulsion of organics (e.g., hydrocarbons) and water having a greater viscosity than the two phases in isolation, and solid fines having a specific gravity approaching that of the organics and water, this waste feed is intractable for traditional treatment methods.

The inventor first applied thermal desorption to the oilfield wastes, which was a novel approach in and of itself, only to find that the supposed ‘treated’ vapors were filled with solid fines, and once the vapors were condensed, a low-quality mixture still high in solid fines remained. Addition of a solids/vapors separator, such as a hot filter (e.g., passing a gas through a heated bed of particles), after the thermal desorption, proved successful in removing the solid fines from the vapor thereby leaving a heretofore unachieved clean vapor stream (herein referred to as the second vapor stream). While previous methods have claimed the ability to ‘treat’ oilfield wastes, no prior method has gone so far to remove solid fines from the product streams.

The systems, methods, and apparatus take oilfield wastes as an input and produce the following outputs: one or more organics, one or more aqueous solutions, one or more solid salt products, and one or more solids products. Each of these can be discrete and purified and can be suitable for sale, beneficial use, reuse within the method, or unrestricted discharge. The systems, methods, and apparatus can accept a wide range of feed compositions, and produce no secondary wastes requiring disposal. This solution not only is applicable to drilling fluids derived from horizontal drilling operations, but is also valuable to the treatment of many other intractable wastes from hydrocarbon exploration, production, and refining. For instance, the herein disclosed systems, methods, and apparatus are applicable to the treatment of slop oil, rag layer, contaminated soil, and tank bottoms, to name a few non-limiting examples.

In one embodiment, the herein disclosed systems, methods, and apparatus further improve upon the art via a more efficient and compact thermal desorber that produces cleaner off-gases and can be fueled by lower quality fuels (lower energy density fuels).

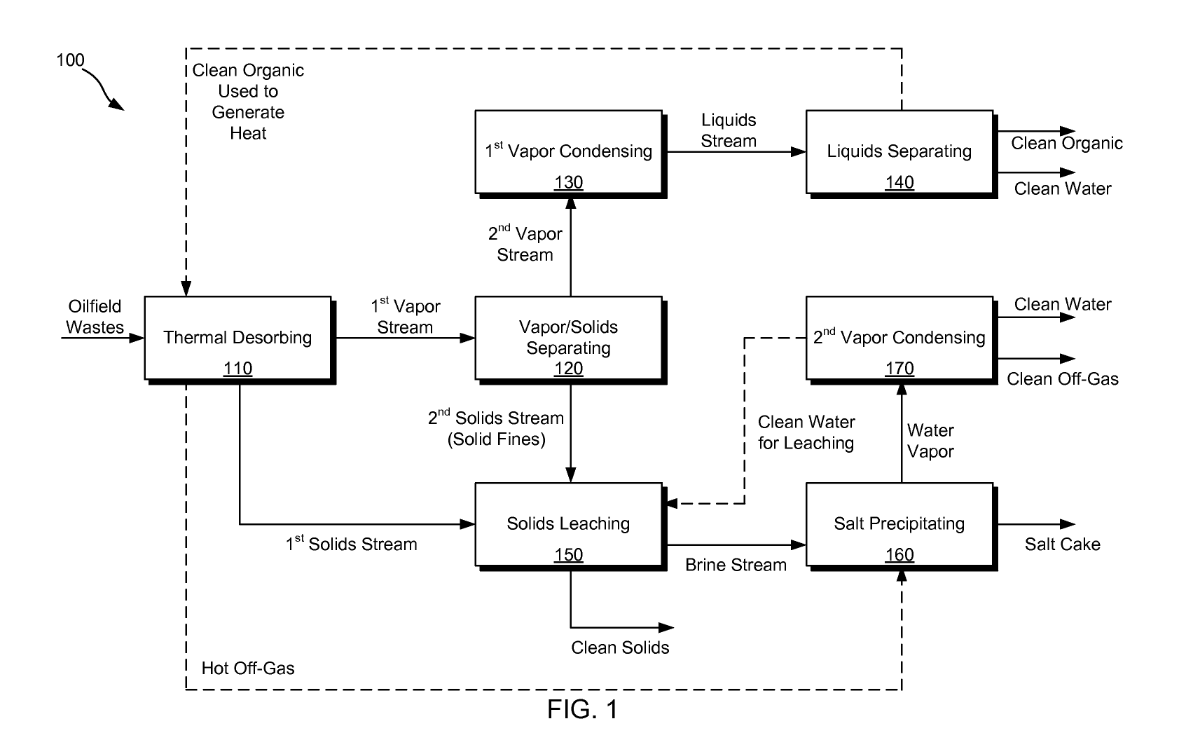

FIG. 1 illustrates one embodiment of a method for separation of emulsions, cuttings and slurry components produced at various points in the hydrocarbon production process. The method 100 takes oilfield wastes (“wastes”) as an input or feed and produces a “clean organic”, “clean water,” “clean off-gas,” “salt cake,” and “clean solids.” The method 100 is a continuous cycle and thus inputs and outputs from method steps can be described as streams as to distinguish the method 100 from discontinuous cycles in the art.

The method 100 begins with a thermal desorbing step 110 that takes wastes as an input and outputs a first vapor stream and a first solids stream. The first vapor stream passes to a vapor/solids separating step 120 that produces a second vapor stream and a second solids stream. The first solids stream from the thermal desorbing step 110 and the second solids stream from the vapor/solid separating step 120 are provided as inputs to a solids leaching step 150. The solids leaching step 150 produces a brine stream and a clean solids stream, the clean solids stream being one of the method's 100 five output streams (six if the two clean water output streams are considered separate streams). The brine stream is provided as an input to a salt precipitating step 160, which then produces a water vapor stream and a salt cake, the salt cake being another of the method's 100 five output streams. The water vapor stream is passed to a water condensing step 170, which produces a clean water stream and a clean off-gas stream, both of which are part of the method's 100 five output streams.

Returning to the second vapor stream from the vapor/solids separating step 120, the second vapor stream is passed to a vapor condensing step 130. The vapor condensing step 130 produces a liquids stream that is passed to a liquids separating step 140. The liquids separating step produces a clean organic stream and a clean water stream. The clean water stream, like that from the water condensing step 170, constitutes one of the method's 100 five output streams as does the clean organic stream.

In some embodiments, portions of the streams so far mentioned can be reused within the method 100. In an embodiment, the clean organic stream from the liquids separating step 140, or a portion thereof, can be used as a combustion fuel to produce some or all of the thermal energy used in the thermal desorbing step 110. The clean organic in the clean organic stream can be a distillate quality. Additionally, a portion or all of the clean water stream(s) can be used to leach the first solids stream in the solids leaching step 150. Furthermore, hot off-gas from the thermal desorbing step 110 can be used to evaporate liquids from the brine stream in the salt precipitating step 160.

The following provides greater specificity as to the output streams. For purposes of this disclosure, the clean organic has a sufficient purity of hydrocarbon products that no further processing is required to reuse the hydrocarbon products, and hence no disposal of the organic or a secondary waste stream is needed. It can preferably be free from water and solids. A monetary value of the clean organic is an inverse function of water and solids concentration. Sufficient purity can render a clean organic “merchantable,” and the clean organic produced by the method 100 achieves this merchantable level of purity.

For the purposes of this disclosure, clean water is sufficiently treated to enable its use as potable water after simple activated carbon filtration to remove trace quantities of soluble organic species. For the purposes of this disclosure clean off-gas is defined as gas resulting from combustion (or combustion gas) exhibiting concentrations of pollutants (e.g., particulates, oxides of nitrogen, carbon monoxide, acid gas, mercury, to name a few) that are well below levels of regulatory concern. Clean off-gas may also be cooled, for instance to room temperature, to ambient or atmospheric temperature, or to temperatures that are above ambient but safe and/or comfortable to human contact. Clean off-gas can comprise nitrogen, oxygen, carbon dioxide, moisture, and low levels of pollutants (e.g., that are well below levels of regulatory concern). For the purposes of this disclosure the salt cake can be a damp or moist solid salt product and can vary in composition depending on the source of the wastes being treated. In an embodiment, the salt cake may be primarily (e.g., >90%) NaCl with minor Na₂SO₄, and corresponding salts of Ca and Mg. The clean solids (e.g., a dirt or mud-like mixture) may be moist but are substantially free of leachable salt and are therefore suitable for unrestricted disposal or beneficial use.

The following details the various steps in the method 100. Oilfield wastes can initially be fed to the thermal desorbing step 110, where a temperature of the oilfield wastes can be raised to a temperature sufficient to vaporize all liquid components (e.g., >350° C.). The thermal desorbing step 110 therefore separates solids and liquids in the oilfield wastes into a first solids stream (e.g., desorbed solids) and a first vapor stream (e.g., adsorbed vapors). For the purposes of this disclosure, “continuous” means that oilfield wastes can be continually provided to the thermal desorbing step 110 without interruption to recycle or rejuvenate any components or materials in the thermal desorbing step 110. The first vapor stream can include organic vapors (e.g., hydrocarbon vapors), water vapor, and fine particulate solids. The first solids stream can include particulate solid minerals and salts.

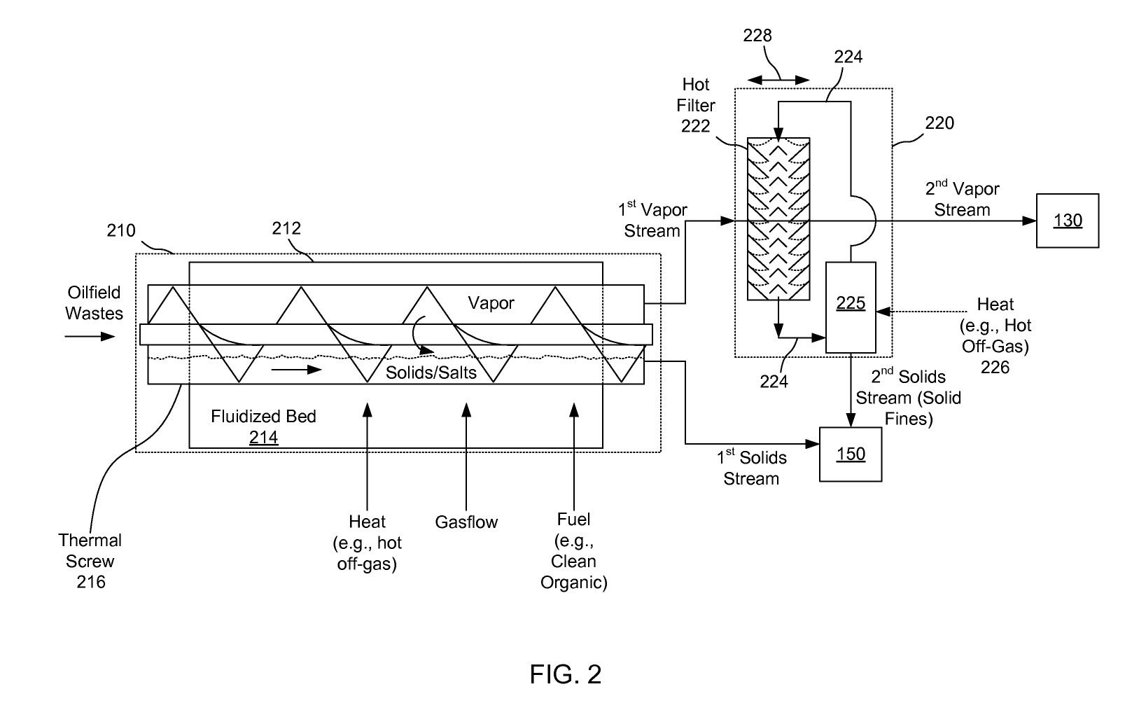

In one embodiment, the thermal desorbing step 110 can be implemented via a thermal screw submerged in a fluidized bed combustor (see FIG. 2). The fluidized bed can comprise sand, alumina, or other media that is maintained at a temperature such as 700° C. to 850° C. or 700° C. to 900° C. Since heat transfer controls throughput for any given feed material, use of a thermal screw submerged in a fluidized bed, for the thermal desorbing step 110, results in a smaller, more compact system when compared to competing systems on the basis of equivalent throughput. This in part enables use of a mobile system that can be used on-site rather than requiring transport of oilfield wastes to an off-site treatment system/facility.

Other means of supplying energy for the thermal desorbing step 110 include, but are not limited to, microwave heating, electrical induction heating, radiant heating, use of synthetic heat transfer fluids, use of high pressure steam, or other heated fluids, and direct contact with heated media Likewise the thermal desorbing step 110 may be conducted in a wide variety of process vessels including, but not limited to screw-augers, drag conveyors, belt conveyors, bomb vessels, rapple grate furnaces, Hirschoff type furnaces, and fluidized bed contactors. The thermal desorbing step 110 can also be carried out continuously, batch-wise, or semi-batch-wise. Continuous operation implies equal feed and discharge rates such that a nearly constant inventory of material is maintained in the process. Batch-wise operation denotes processing of discrete amounts of feed material such that the inventory of material in-process at any given time is the batch size. Semi-batch operation implies a process that feeds from and/or discharges to a batched tank. Semi-batch operation can include feeding from pre-mixed or pre-staged batches.

The thermal desorbing step 110 can be augmented by stripping (e.g., steam stripping) of desorbed solids in, or produced by, the thermal desorbing step 110. In the case of a thermal screw submerged in a fluidized bed, water or steam can be injected into an end of the thermal screw housing (e.g., an output end) to provide a stream of superheated steam that flows counter to the direction of solids flow, and aids in stripping any residual organics from the desorbed solids. In some embodiments, the products of the thermal desorbing step 110 can be referred to as absorbate vapors (vapors) and desorbed solids (solids).

Vapors (e.g., adsorbate vapors) from the thermal desorbing step 110 (a first vapor stream) are fed to a vapor/solids separating step 120 where the vapors can be separated into a second vapor stream and a second solids stream. In an embodiment, the second vapor stream can be a mixed vapor comprising solids-free mixed organic vapor and water vapors. The first vapor stream may also include contaminants in both vaporized and solid form (e.g., barite, biological materials, dust, and proppants). In an embodiment, the second solids stream can include solid fines and possibly a solids fraction of contaminants. In one embodiment, the separation is accomplished via the addition of heat. For instance, the vapor/solids separating step 120 can involve hot filtration or a hot filter (see e.g., FIG. 2). One example of hot filtration is to pass the first vapor stream from the thermal desorbing step 110 through a moving bed granular hot filter. Alternative methods of separating the first vapor stream into a second vapor stream and a second solids stream can include, but are not limited to, use of electrostatic precipitation, sintered metal filtration, sintered ceramic filtration, fixed bed granular filtration, and use of high efficiency hot cyclones, which are all methods of separating particulates from hot gas.

Electrostatic precipitation utilizes an electric field to induce a surface charge on particulate solids, which are then removed downstream by an electrode array that is supplied with opposite charge. Electrostatic precipitators are more effective filters for certain particles. Sintered metal filters and sintered ceramic filters sieve out solid particles from a gas stream. However, as the solid fines collect on the filters they eventually must be cleaned off via blowing back or back flowing of gas to remove the solid fines. These filters also create high pressure drop and require large surface area to filter fine particles at a reasonable pressure drop. Sintered filters can also be permanently fouled by liquid organics and they are expensive. High efficiency cycloneses, or multi-clones, as compared to typical cyclones are required for filtering solid fines from gases. They also require a high-velocity gas stream to provide sufficient centrifugal forces needed to separate solid fines from gas. Consequently, high efficiency cyclones exhibit high pressure drop and are not preferred candidates for removal of particles<10 μm unless pressure drop is not an issue. For some streams, such as raw drill cuttings off of a rig's shaker table, use of an insulated cyclone may be utilized to remove entrained solids via the method 100.

In the case of a moving bed granular hot filter, test data show that proper selection of media for use in the moving bed granular hot filter can significantly increase the value of organics produced by the hot filter, as compared to organics in the oilfield wastes. In particular, as the first vapor stream passes through the vapor/solids separating step 120, the concentration of diesel-range organics (these include diesel fuels and by-products thereof and are more valuable than heavy or light organics) increases and hydrogen sulfide concentrations are decreased. This combination of improvements makes the organics emanating from the solids/vapors separating step 120 more valuable (or merchantable) than the organics fraction that entered the solids/vapors separating step 120. More specifically, it was found that some of the heavier organics are cracked and some of the lighter organics are reformed when the first vapor stream passes through a moving bed granular hot filter having activated alumina as the filter media. While this decreased the concentration of light and heavy organics, it increased the concentration of diesel-range organics. Hydrogen sulfide was also removed as a non-condensable gas and total sulfur was reduced. Thus, not only does the method 100 recover organics from oilfield wastes that would otherwise be wasted, but the quality of the recovered organics is superior to the quality of the organics fraction in the oilfield wastes.

Vapors from the vapor/solids separating step 120 are condensed in a vapor condensing step 130, for instance, in a direct contact adsorbate condenser supplied with cooling fluid (CS) from a coolant supply system. The vapor condensing step 130 can employ a counter-current packed bed tower that is fitted with a demister through which any non-condensable gas, entrained with the second vapor stream, may be vented. Other direct contact condensers that may be used include, but are not limited to, ejector venturi scrubbers, spray towers (e.g., packed spray towers), spray tunnels, wet cyclones, and sparged tanks. Indirect contact heat exchangers (e.g., shell and tube, spiral plate, plate and frame, etc.) may also be used to condense the second vapor stream.

Condensed liquids from the vapor condensing step 130 are separated in a liquids separating step 140. The output can be an organic phase and an aqueous phase. In one embodiment, the organic phase can be a clean organic and the aqueous phase can be clean water. The clean organic can include liquid organics (e.g., hydrocarbons). The liquids separating step 140 can be carried out via one or more gravitational mechanisms. For instance, the liquids separating step 140 can be implemented in a horizontal coalescing gravity decanter, centrifuge, centrifugal decanter, coalescing filter, pervaporation system, or distillation system, to name a few.

Solids from the thermal desorbing step 110 and solids from the vapor/solids separating step 120 can be provided to a solids leaching step 150. Solids exiting the thermal desorbing step 110 can be hot desorbed solids (e.g., dry solids). The solids leaching step 150 leaches salt from the first and second solids input streams, and provides two output streams: a brine stream (or pregnant liquor stream) and a clean solids stream. In an embodiment, the brine stream can be a stream of aqueous salt brine. The solids leaching step 150 can include cooling the solids and/or leaching them using clean water (e.g., leach water). In an embodiment, the clean water can be provided by an output of the water condensing step 170 and/or the liquids separating step 140.

In one embodiment, a continuous solids leacher can be used to perform the solids leaching step 150. The continuous solids leacher can be an inclined screw conveyor coupled with a solids separator. In another embodiment, the continuous solids leacher can comprise an inclined leaching screw (or auger) coupled to a lamella-type thickener. The lamella-type thickener and inclined leach auger can be arranged so that the static liquid level in the leacher is below an end of the auger by an elevation that allows draining of the solids. The lamella-type thickener reduces a number of suspended solids in the pregnant liquor exiting the leacher.

The solids leaching step 150 can be implemented via countercurrent flow of clean water against a flow of solids. This enhances intimate contact of the solids and liquid phases. The solids leaching step 150 can be carried out via other apparatus and methods including, but not limited to, Pachuca tanks, Kennedy extractors, Bonotto extractors, mixer-settlers, sequential clarifiers, pulsed columns, and bag filters.

The brine stream (or a pregnant liquor) can be provided to the salt precipitating step 160, which precipitates a salt cake (possibly a damp salt cake) from the brine and generates water vapor or a wet gas. Thermal energy for carrying out this evaporation and crystallization step can be provided by directly contacting the brine stream with hot off-gas from the thermal desorbing step 110 and/or from another source. The salt precipitation step 160 can be carried out via a direct contact crystallizer, for instance. In another embodiment, the salt preparation step 160 can be carried out via an ejector venturi scrubber possibly coupled to a conical crystallizer sump. Once cooled and cleaned, saturated off-gas can exit (e.g., exit the crystallizer sump) through a demister in the head space of a crystallizer sump. Crystallizers of conventional design (indirect contact) may also be used for this application, but may result in decreased energy efficiency. In an embodiment, the salt precipitating step 160 can be carried out via a salt crystallizer such as a psychrometric direct contact evaporator. Such a device can use off-gas from the thermal desorbing step 110 to evaporate water vapor from the brine stream. In an embodiment, hot off-gas from the thermal desorbing step 110 can be directly contacted with the brine stream via an ejector venture scrubber.

The moist gas can be provided to a water condensing step 170 that condenses the moist gas to produce clean water and clean off-gas. The water condensing step 170 can be carried out via a direct contact water condenser. Alternatively, a packed spray tower and a sump that provides counter-current contact of up-flowing gas and vapor against a downward flowing stream of cooled water can be used. The cooled water can be generated by the liquids separating step 140. In an embodiment, the clean off-gas can exit via a demister located in a headspace of the packed spray tower.

The clean off-gas differs from the moist gas input to the water condensing step 170 in that it has a lower water content and has been cooled via condensation. The clean water can collect, for instance in a sump, and can be pumped for recycle or other uses via a coolant supply system. The water condensing step 170 may maintain an inventory of clean water and only water levels exceeding a defined inventory are discharged as part of the clean water output stream. When a clean water inventory is maintained, the method 100 may be continuous, but the discharge of clean water may be discontinuous.

FIG. 2 illustrates one embodiment of a system for carrying out the thermal desorbing and vapor/solids separating described in FIG. 1. In the illustrated embodiment, the thermal desorbing 110 can be carried out via a thermal desorber 210 and the vapor/solids separating 120 can be carried out via a hot filter system 220. The thermal desorber 210 vaporizes organics in the oilfield wastes thus generating a first vapor stream and a first solids stream. The first vapor stream can include organic vapor and water vapor, but also solid fines that were small enough to become entrained in the first vapor stream generated inside a thermal screw 216. The first vapor stream may also include contaminants in both solid and vapor forms (e.g., barite, biological materials, dust, proppants, to name a few). Thus, the first vapor stream is passed through a hot filter system 220 to separate the solid fines from the first vapor stream thus forming a second vapor stream (e.g., clean organic and water vapor) and a second solids stream (e.g., solid fines and contaminants). The second vapor stream may include vaporized fractions of contaminants while the second solids stream may include non-vaporized fractions of contaminants. The second vapor stream can be passed to the vapor condensing 130 described in FIG. 1 to be condensed and then separated into a clean organic and a clean water in the liquids separating 140. The first solids stream and the second solids stream can be provided to the solids leaching 150 described in FIG. 1.

The thermal desorber 210 can include a thermal screw 216, a fluidized bed 214, a heat input, an airflow input, and a clean organic input (the heat and airflow inputs may or may not be one and the same). The thermal screw 216 can comprise a rotating mechanism (e.g., an auger) that moves oilfield wastes from a first position to a second position within a housing such as a tubular housing (e.g., from left to right in FIG. 2). Heat from the fluidized bed combustor 212 transfers into the oilfield wastes as they move through the thermal screw 216. The housing can be made of a thermally conductive material such as metal.

The thermal screw 216 can be submerged (partially or fully) in the fluidized bed 214. The fluidized bed 214 can comprise sand or some other media (e.g., particulate media) that is maintained in a fluidized state via an appropriate volume and flow rate of air or other gas that can, for instance, enter the fluidized bed 214 from a bottom of the fluidized bed 214. In an embodiment, the gas flow can be provided by hot off-gas from another portion(s) of the system 100. In another embodiment, the fluidized bed 214 can be supplied with heated combustion gasses from a forced air blower.

In an embodiment, the temperature of the fluidized bed 214 can be maintained by in-bed combustion of recovered organic components (recovered from other steps in the method 100 such as the liquids separating step 140) and/or supplementary fuel. In an embodiment, the heated combustion gasses can be sourced from an oil burner or other thermal-energy-generating mechanism. A fuel, such as clean organic produced from the liquids separating 140 of FIG. 1, can be combusted within the fluidized bed 214 at a temperature controlled at least in part via the addition of heat to the fluidized bed 214. The combusting of the fuel generates heat that transfers into the oilfield wastes in the thermal screw 216 via the housing. Heat transfer to the housing can be via convection, conduction, and radiation. The addition of heat to the oilfield wastes vaporizes organics and water within the thermal screw 216, and these vapors exit the thermal screw 216 as the first vapor stream. Solids that are not vaporized leave the thermal screw as the first solids stream. In an embodiment, all organics in the oilfield wastes are vaporized in the thermal screw and exit via the first vapor stream.

The thermal screw 216 can be replaced by any mechanism designed to move the oilfield wastes through the fluidized bed combustor 214 and enable heat transfer from the fluidized bed 214 to the oilfield wastes without direct contact between the media in the fluidized bed 214 and the oilfield wastes.

While traditional thermal desorbers such as indirect heating desorbers and hammermill thermal desorbers can be implemented, the illustrated embodiment enables a smaller system producing less noxious off-gases, with greater fuel-to-heating efficiency, and the ability to combust lower quality fuels. While traditional indirect thermal desorbers (or convective thermal desorbers) often use a flame to transfer heat to a thermal screw housing primarily via radiation and convection, the fluidized bed 214 enables conduction from the media in the fluidized bed 214 to the housing to dominate heat transfer—a much more effective means of heat transfer than radiation or convention. For instance, traditional burner-type thermal desorbers can lose 80% of the generated heat as exhaust gases, and thus only transfer about 20% of thermal energy to the oilfield wastes. Thus, the fluidized bed combustor 212 transfers a greater percentage of energy from the fuel to the oilfield wastes than traditional thermal desorbers.

At the same time, the media in the bed can be closer to the housing, and since radiative heat transfer is exponentially related to distance, a fluidized bed radiates heat into the housing far more effectively than a flame-based system. Furthermore, radiation is a function of view angle, and a fluidized bed has a far greater view angle of the housing than does a flame in a traditional burner. Therefore, radiative heat transfer is also enhanced via a fluidized bed.

Because of the improved thermal transfer of the fluidized bed 214, heating of the oilfield wastes is more efficient, which in turn enables a smaller (e.g., shorter) thermal desorber 210 to be used, assuming equivalent throughput. For instance, to achieve the same degree of thermal transfer in a traditional indirect heating thermal desorber, a much longer thermal screw would typically be used.

Use of the fluidized bed combustor 212 also enables lower-temperature combustion, combustion without a flame, and combustion of lower quality fuels (e.g., fuels having lower heat value) due to the catalyzing effect of the fluidized bed media. In typical liquid or gas combustion, fuel molecules and oxidants (the reactants) must impact each other with enough energy to overcome their activation energy and thereby react in a combustion reaction. High temperatures are required to achieve typical activation energies. In contrast, in a fluidized bed combustor, the reactants are attracted to activated sites on the media in the fluidized bed. In effect, adsorption of reactants on the fluidized bed solids greatly increases the reactant density and provides many more opportunities for fuel molecules and oxidants to encounter one another and react. Upon reaction, the reaction products are desorbed from the active sites so that they can again attract and adsorb fuel molecules and oxidants. In this way, the catalyst promotes the reaction, but is not consumed during the reaction. The net effect is that the catalyst greatly reduces the activation energy needed to drive the combustion reactions.

Catalysts are therefore preferred media for the fluidized bed 214. Given a fuel comprising the clean organics produced by the method 200, preferred catalytic media can be formed from select substrates such as silica, alumina, zeolite, and iron oxide, to name a few. The substrate may, but is not required to be, doped with a transition metal, a metal oxide, or a noble metal (e.g., nickel, chromium, cadmium, vanadium, silver, platinum, titania, and zirconia, to name a few).

This catalytic combustion decreases an ignition temperature of the fuel, or, said another way, promotes catalytic combustion of fuel without a flame. For instance, in one embodiment, the fluidized bed 214 operates at 700-850° C., which is far below a temperature required for combustion in a flame. Because fuels can be burned at much lower temperatures, less NOX, CO and other harmful off-gases are produced, and accordingly the exhaust gases are easier to put to further use (e.g., within the method 100) or can be released into the atmosphere with far less harm to the environment.

Use of catalytic type combustion in a bed of solids also means that a wider variety of fuels, and lower quality fuels, can be burned (e.g., fuels that would typically require much higher ignition temperatures, or which have too low a heating value for flame type combustion). For instance, the inventor has successfully burned rag layer (which includes 30% water), chicken dung, slop oil, tank bottoms, and many other substances that would never be considered ‘fuel’ in traditional thermal desorbers. In an embodiment, fuels for the fluidized bed combustor 212 can include any substance having greater than about 450 BTU/lb of net heating value. In comparison, traditional thermal desorbers often require fuels having at least 18,000 BTU/lb of net heating value. Net heating value is heat available when all fuel values are burned minus the energy needed to raise the temperature of the combustion products and impurities (e.g., moisture, solids, inerts, etc.) to the combustion temperature. In other words, net heating value is the best measure of a fuel's ability to provide heat needed to do useful work (or the ability of a solution/emulsion that includes fuel to do useful work). Where fuel is mixed with other substances having much lower energy values, the energy value of the mixture is reduced as compared to the pure fuel

The ability to burn low-quality or dirty fuels is particularly useful since clean organic from the liquids separation 140 described in FIG. 1 can be used as the fuel for the fluidized bed combustor 212 despite being generally unsuitable for use in conventional oil burning equipment (e.g., because of variable viscosity, variable specific gravity, variable heating value, and possibly sufficient bottom sediment and water to render them unsuitable for combustion in a conventional oil burner). Traditional systems, like indirect heating thermal desorbers (e.g., burners under a housing of a thermal screw) and direct heating thermal desorbers (e.g., hammermills) require much higher fuel qualities (mixtures having higher heating values) and thus are incapable of reusing the organic products (e.g., hydrocarbon products) that such systems produce. For instance, hammermills are often driven using electric motors. Electricity is one of the highest value forms of energy, because it is an end product of an inefficient energy conversion process. Hammermills thus require clean, refined, high heating value, and expensive fuels. As another example, traditional systems could not use a clean organic that they produce as the fuel for the thermal desorber of the system because the properties of the recovered fuel are variable and generally not suitable for direct feed to conventional fuel fired burners. Because of the catalytic effect of the fluidized bed combustor 212, the herein disclosed systems, methods, and apparatus are capable of burning fuels (or mixtures including fuel) of variable quality and having much lower heating values than a traditional flame-type burner can.

In some embodiments, there may be a preference for uniform particle size in the fluidized bed 214. Various particle sizes can be used in the fluidized bed 214. For instance, 20-200 mesh, 35-70 mesh, or 60 mesh particle sizes can be used. Coarser particles may require higher airflow velocities to fluidize the bed 214. In an embodiment, a 1 ft/s airflow is used to fluidize the bed 214. Activated alumina, coarse alumina, sand, dolomite, and fine nickel shot are a few non-limiting examples of materials that can be used as the media of the fluidized bed 214. The media may be refractory (able to withstand the temperatures of the fluidized bed combustor 212 without degrading) and they may have a substantial relative hardness (ability to withstand the mechanical rigors of being fluidized without degrading).

Although the heat, airflow, and fuel are illustrated as entering the fluidized bed 214 from a bottom of the fluidized bed 214, one or more of these flows can enter from other directions and from different directions relative to each other.

Discussion now turns to the hot filter system 220. Traditional systems have attempted to use thermal desorbers (although different in type from the one herein disclosed) to achieve various treatments of waste feeds, and while thermal desorption alone can separate valuable products from waste feeds in many cases where solid fines are not an issue, where the waste feed comprises an emulsion of organics (e.g., hydrocarbons), water, and solid fines, thermal desorption alone fails to separate the fines, which are largely carried out of solution with the vapor stream. For this reason, traditional thermal desorbers have been unable to treat waste feeds including emulsions of organics, water, and solid fines.

The inclusion of a solids/vapors separator, such as the hot filter system 220 to treat the first vapor stream can overcome this challenge. As noted in FIG. 1, separation of solids from a mixture/solution is much easier in the vapor than in the liquid state. The hot filter system 220 can include a hot filter 222 (e.g., a moving bed granular filter), a solids-solids separator 225, and a return path 224 that removes filter media from one port of the hot filter system 220 and returns it via a second port of the hot filter system 220 while also passing contaminated filter media through the solids-solids separator 225.

The first vapor stream can be passed through the hot filter 222, where solid fines impact and are attracted to the filter media in the hot filter 222 and are thereby removed from the vapor stream leaving a second vapor stream exiting the hot filter 222. The second vapor stream is substantially free of solid fines and thus ready for condensation and separation into the clean organic and the clean water streams discussed relative to FIG. 1. In the illustrated embodiment, gravity moves the filter media from a top of the hot filter 222 toward a bottom of the hot filter 222. Contaminated filter media (having solid fines attached to the particles in the filter media) is removed from or near a bottom of the hot filter 222 and returned via a top, or a position near the top, of the hot filter 222 via a return path 224.

During transit along or through the return path 224, the contaminated filter media can pass through the solids-solids separator 225, which removes the solid fines from the contaminated filter media as the second solids stream. This leaves clean filter media that can be reintroduced at a top of the hot filter 222. The solids-solids separator 225 can encompass a portion or all of the return path 224. In other words, solids-solids separation can take place during a portion or the entire journey along or through the return path 224.

To avoid condensation of the first vapor stream (either or both of the organic and water phases), the hot filter 222, and in particular the filter media, is maintained at or above a vaporization temperature of the organic and water constituents of the first vapor stream. Thus, the hot filter system 220 also includes a heat input 226. Heat that enters via the heat input 226 can be used to heat the filter media as it enters the hot filter 222, while it is passing through the hot filter 222, in the return path 224, or while the filter media is in the return path 224, to name a few non-limiting examples. In the illustrated embodiment, the heat input 226 transfers the heat to the solids-solids separator 225, thus applying the heat to the filter media during its transit through or along the return path 224. The particular means for heating the filter media is not limiting so long as the filter media is hot enough to prevent condensation of the first vapor stream.

Although other apparatuses can be used, in the illustrated hot filter 222, guide members arranged in a chevron pattern are arranged so that the filter media gradually descends through the hot filter 222 while also being dispersed over a desired width 228 across which the first vapor stream must pass while being filtered. The width 228 of the filter media can be designed so that substantially all solids are removed from the first vapor stream as it passes through the filter media.

The hot filter 222 may also be structured such that the first vapor stream passes through the filter media at a low or reduced velocity, thus increasing contact time between the first vapor stream and the filter media and also preventing the air flow from disturbing the distribution of filter media in the hot filter or even blowing the filter media out of the hot filter 222. For instance, the first vapor stream may be directed through a baffles before entering the hot filter 222, or the baffles may be incorporated into the hot filter 222, thus slowing the airflow of the first vapor stream as it enters the hot filter 222.

The solids-solids separator 225 can include any apparatus or system able to separate the solid fines from the contaminated filter media. In one embodiment, a blower can pass air through the contaminated filter media, and due to a density and particle size difference between the solid fines and the filter media, the two particle types can be separated. In one embodiment, off-gases from other portions of the system 100 can be used to blow the solid fines off of the contaminated filter media. For instance the hot off-gas from the thermal desorbing 110 in FIG. 1, or hot off-gas from the thermal desorber 210 can be used to blow the solid fines off of the contaminated filter media. Use of such hot off-gases also reduces an amount of heat that must be generated in order to keep the hot filter 222 at a temperature sufficient to prevent condensation. In some instances, use of hot off-gases from elsewhere in the treatment system may preclude the need for any heat generation. In instances where the off-gas does not transfer enough thermal energy to the filter media to prevent condensation, a secondary source of heat may be used to achieve the requisite temperatures in the hot filter 222.

The filter media may be selected to enhance the removal of solid fines from the first vapor stream. Solid fines are filtered via inertial impaction, interception, diffusion and electrostatic attraction to the filter media particles and then sticking to them via electrostatic, frictional, or surface capture forces. Filter media that enhance electrostatic attraction to the solid fines are preferred. In many cases the electrostatic forces are a byproduct of the solid fines and vapors passing by and through the filter media, and especially in light of the water vapor moving through the filter media. However, some filter media may enhance the electrostatic charge buildup as compared to others. In some cases, electrostatic charges can be induced on the filter media by an externally applied electric field or insertion of electrodes in the media. The filter media may also have a substantially constant particle size and may comprise all or a majority of spherical particles. The filter media may also have a high relative hardness and a high specific surface area. In one embodiment, filter media particle size can be 1-2 mm. Some non-limiting examples include sand, alumina, dolomite, sintered metal, and sintered ceramic.

It is also preferable to use a filter media that makes for a low pressure drop across the hot filter 222. For instance, sintered metal or sintered ceramic causes a high pressure drop across the hot filter 222, which leads to a need for greater energy to push air through the hot filter 222 and also leads to increased safety concerns.

The following discussion helps illustrate why separation of solid fines from a vapor rather than from a liquid, is more effective than any treatment methods known in the art. Conventional organic/solids separation technologies are defeated by the physical characteristics and composition of the feed materials, and the inherent limitations of the separation technologies applied. For example, the rate of pressure filtration is governed by Poiseuille's equation which may be adapted in the following form:

$$\frac{d V}{A d θ} = \frac{P}{μ [ α ( W \text{/} A ) + r ]} \qquad ( Equation 1 )$$

Equation 1 shows that, the rate of separating solids from the oilfield wastes feed (dV/dΘ) is inversely proportional to fluid viscosity (μ). Fluid viscosity in the vapor phase is about 1/200^{th} of the viscosity of the same material in the liquid phase. Thus, separation of a vapor feed (e.g., step 120) compared to a liquid feed (traditional treatments) is more effective since fluid viscosity (in the denominator) is smaller. The mass loading (W/A) is proportional to a product of a solids concentration and a fluid density, and thus a lower solids concentration in the vapor phase and lower fluid density (less than 1/1000^{th} than in the liquid phase) further reduces the denominator thus increasing the rate of filtration (dV/dΘ). In other words, it is greater than five orders of magnitude easier to filter fine solids from a vapor than from a liquid.

Similarly, solids separation by sedimentation and centrifugation (as is often performed in the art) is governed by Stokes-law, which adapted for the case of centrifugation is:

$${v}_{t} = \frac{{ω}^{2} r ( {ρ}_{p} - {ρ}_{f} ) {D}_{p}^{2}}{18 μ} \qquad ( Equation 2 )$$

Equation 2 shows that for a given centrifuge speed (ω) and bowl radius (r), the terminal velocity (vₜ) of a particle having a given diameter (Dₚ), is directly proportional to the product of the difference between the particle and fluid densities (ρₚ−ρ_{f}), and the square of the particle diameter (Dₚ). Bowl radius is a distance between a drive axis and inside wall of a cylindrical portion of the bowl in a solid bowl, screw conveyor continuous centrifuge. The particle terminal velocity is inversely proportional to the viscosity of the fluid. In other words, separation of particles from fluids by centrifugation becomes very difficult for small, low density particles (e.g., solid fines) in viscous fluid. Oilfield waste emulsions and slurries exhibit very small (micron to submicron) average particle size in suspensions that exhibit apparent viscosities and densities that are greater than those of water. Consequently, attempts to clarify, and separate, said wastes into pure component phases by means of centrifugation is ineffective and instead results in generation of an organic waste fraction that is enriched with fine solids.

The challenges inherent to the above have proven insurmountable for decades. This disclosure overcomes these challenges via systems, methods, and apparatus for efficient and substantially complete removal of solid fines from mixed organic and aqueous oilfield waste components by means of at least the thermal desorbing step 110 and the vapor/solids separating step 120 (which can be a hot separation), or the thermal desorber 210 and the hot filter system 220.

In conclusion, the herein described CUTTFLO process provides an innovative and complete solution to the difficult and heretofore unresolved problem of managing oilfield wastes. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A method for treating oilfield wastes comprising:
separating an oilfield waste feed into a first vapor stream and a first solids stream via thermal desorption, the first vapor stream comprising hydrocarbon vapor, water vapor, and solid fines, the first solids stream comprising salts and solids having a larger average mass than the solid fines; and
separating the solid fines from the first vapor stream to produce a second vapor stream and a second solids stream, the second vapor stream comprising hydrocarbon and water vapors and being substantially free of solids.

2. The method of claim 1, further comprising:
condensing the second vapor stream to form a first liquids stream comprising liquid hydrocarbons and liquid water;
separating the first liquids stream into a first clean liquid water stream and a clean liquid hydrocarbon stream;
leaching the first and second solids streams with water to produce a clean solids stream and aqueous brine;
evaporating the aqueous brine to produce a precipitated salt stream and a water vapor stream; and
condensing the water vapor stream to produce a second clean water stream and a clean off-gas stream.

3. The method of claim 1, wherein at least a portion of the liquid hydrocarbon stream is used to generate heat for the thermal desorption.

4. The method of claim 1, further comprising steam stripping of desorbed solids from or in the thermal desorption.

5. The method of claim 1, wherein the leaching is performed using at least a portion of the first and/or second clean water streams.

6. The method of claim 1, wherein off-gas from the thermal desorption provides at least a portion of heat used in the evaporation of the aqueous brine.

7. The method of claim 6, wherein at least a portion of the heat for the evaporation of the aqueous brine is transferred to the aqueous brine via direct contact of the off-gas with the aqueous brine.

8. A system for treating oilfield wastes comprising:
a thermal desorber, receiving waste feed and producing a first stream of hydrocarbon and water vapors that contain some solid fines and a second stream of mineral and salt solids that are substantially free of hydrocarbons and moisture;
a hot vapor filter, receiving said first stream of hydrocarbon and water vapors that contain some solid fines, and generating a solids-free vapor stream and a stream of solid fines;
a vapor condenser, receiving the solids-free vapor stream, and generating a mixed liquids stream comprising hydrocarbons and water;
a liquids separator, receiving the mixed liquids stream, and generating a liquid hydrocarbon stream and a first liquid water stream;
a solids leacher, receiving said second stream of mineral and salt solids from the thermal desorber and receiving said stream of solid fines from the hot vapor filter, and generating a stream of salt-free damp solids, and a stream of salt brine;
a salt crystallizer, receiving the stream of salt brine, and generating damp salt cake and water vapor; and
a water vapor condenser, receiving the water vapor, and generating a second liquid water stream.

9. A system comprising:
a thermal desorber receiving an oilfield waste feed and applying thermal energy to the oilfield waste feed in order to vaporize liquid components in the oilfield waste feed thus generating a first vapor stream and a solids stream, the solids stream including a first portion of solids in the oilfield waste feed; and
a hot filter receiving the first vapor stream and filtering the first vapor stream in order to remove a second portion of solids from the first vapor stream thus generating a second vapor stream and a second solids stream,
an average particle mass of the second solids stream being smaller than an average particle mass of the first solids stream.

10. The system of claim 9, wherein the thermal desorber is a thermal screw submerged in a fluidized bed combustor.

11. The system of claim 10, wherein a media in the fluidized bed combustor is maintained above a vaporization temperature of vapors in the first vapor stream.

12. The system of claim 11, wherein the media is a catalyst for combustion of a clean organic produced by the system.

13. The system of claim 9, wherein the first vapor stream includes organic vapor, water vapor, and fine particulate solids.

14. The system of claim 9, wherein the first and second solids streams are provided to means for solids processing that further process the first and second solids streams and generate clean solids, dry salt, clean water, and clean off-gas.

15. The system of claim 14, wherein hot off-gas from the thermal desorber is provided to the solids processing means to aid in generating the dry salt.

16. The system of claim 15, wherein at least a portion of the clean water is recycled to aid in generating the clean solids.

17. The system of claim 15, wherein the second vapor stream is provided to vapor processing means that further process the second vapor stream and generate clean liquid organics and clean water.

18. The system of claim 17, wherein at least some of the clean liquid organics are combusted to generate thermal energy used in the thermal desorber.

19. The system of claim 18, wherein at least some of the clean liquid organics are used as fuel for the fluidized bed combustor.

20. The system of claim 9, wherein the hot filter is a moving bed granular filter.

21. The system of claim 20, wherein a media of the hot filter is selected from the group consisting of: sand, alumina, zeolite, graphite, and dolomite.

22. The system of claim 9, wherein a media in the hot filter is maintained above a vaporization temperature of vapors in the first vapor stream.
